(19) United States
(12) Patent Application Publication
(10) Pub. No.: US 2003/0153282 A1
(43) Pub. Date: Aug. 14, 2003

(54) Mobile phone with replaceable key assemblies

(75) Inventors: Hsueh-Wen Sun, Shinjuang City (TW); Yin-Shiang Cheng, Shijr City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ Corporation

(21) Appl. No.: 10/241,920

(22) Filed: Sep. 12, 2002

(30) Foreign Application Priority Data
Feb. 8, 2002 (TW) 91201739

(51) Int. Cl. H04B 1/38

(52) U.S. Cl. 455/90; 455/575; D14/137; D14/138

(57) ABSTRACT

A mobile phone with replaceable key assemblies. The mobile phone comprises a body, a printed circuit board, and a key assembly. The printed circuit board, including a plurality of pads, is disposed on the body. The key assembly, including a plurality of keys corresponding to the pads of the printed circuit board respectively, is disposed on the body in a replaceable manner.

### BACKGROUND OF THE INVENTION

1. Field of the Invention

The invention relates to a mobile phone; in particular, the invention relates to a mobile phone with replaceable key assemblies.

2. Description of the Related Art

Due to the boom in modem technology for communication, mobile phones have become a daily necessity for users. In order to grasp the trend, telecommunication manufacturers focus on enhancing function in the phones. Presently, each of the mobile phones has only one key assembly; that is, the key assembly is built into the body of the mobile phone. Thus, the key assembly cannot be replaced.

As mobile phone functions increase, only one key assembly cannot handle all of the functions. For example, when the user wants to play games built into the mobile phone, it is very inconvenient to control via the original key assembly. In addition, as mobile phone functions increase, the design of the key assembly becomes complicated. For the elders and children, the original key assembly may be difficult to read; therefore, they may press the wrong key during operation.

### SUMMARY OF THE INVENTION

In order to address the disadvantages of the aforementioned mobile phone, the invention provides a mobile phone with replaceable key assemblies.

Another purpose of this invention is to provide a mobile phone with replaceable panels or housings.

Accordingly, the invention provides a mobile phone with replaceable key assemblies. The mobile phone comprises a body, a printed circuit board, and a key assembly. The printed circuit board, including a plurality of pads, is disposed on the body. The key assembly, including a plurality of keys corresponding to the pads of the printed circuit board respectively, is disposed on the body in a replaceable manner.

In a preferred embodiment, the mobile phone further comprises a panel. The panel is disposed on the body in a replaceable manner, and includes a plurality of through holes for the keys of the key assembly to pass through.

Furthermore, the body includes a plurality of engaging holes, and the panel includes a plurality of hooks corresponding to the engaging holes respectively. Thus, the panel is disposed on the body by the hooks engaging with the engaging holes.

In another preferred embodiment, the mobile phone further comprises a housing. The housing is disposed on the body in a replaceable manner, and includes a plurality of through holes for the keys of the key assembly to pass through.

Furthermore, the body includes a plurality of engaging holes, and the housing includes a plurality of hooks corresponding to the engaging holes respectively. Thus, the housing is disposed on the body by the hooks engaging with the engaging holes.

In another preferred embodiment, the plurality of pads has a switch pad, and the plurality of keys has a switch key corresponding to the switch pad. Thus, the printed circuit board recieves signals from the key assembly by the switch key contacting the switch pad.

In another preferred embodiment, this invention provides an electronic device with replaceable key assemblies. The electronic device comprises a body, a printed circuit board, and a key assembly. The printed circuit board, including a plurality of pads, is disposed on the body. The key assembly, including a plurality of keys corresponding to the pads of the printed circuit board respectively, is disposed on the body in a replaceable manner.

### BRIEF DESCRIPTION OF THE DRAWINGS

The invention is hereinafter described in detail with reference to the accompanying drawings in which:

FIG. 1a is an exploded view of a mobile phone as disclosed in this invention;

FIG. 1b is a front view of the assembled mobile phone in FIG. 1a;

FIG. 2a is another exploded view of a mobile phone as disclosed in this invention;

FIG. 2b is a front view of the assembled mobile phone in FIG. 2a;

FIG. 3a is another exploded view of a mobile phone as disclosed in this invention;

FIG. 3b is a front view of the assembled mobile phone in FIG. 3a; and

FIG. 4 is a schematic view that shows the relationship between a printed circuit board and key assemblies.

### DETAILED DESCRIPTION OF THE INVENTION

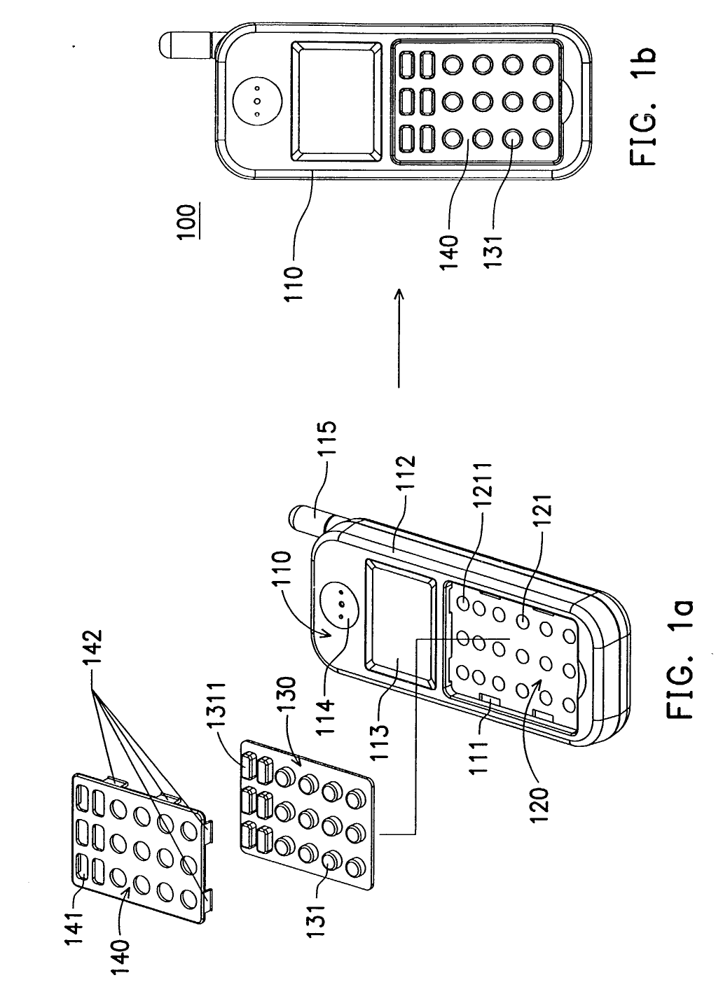

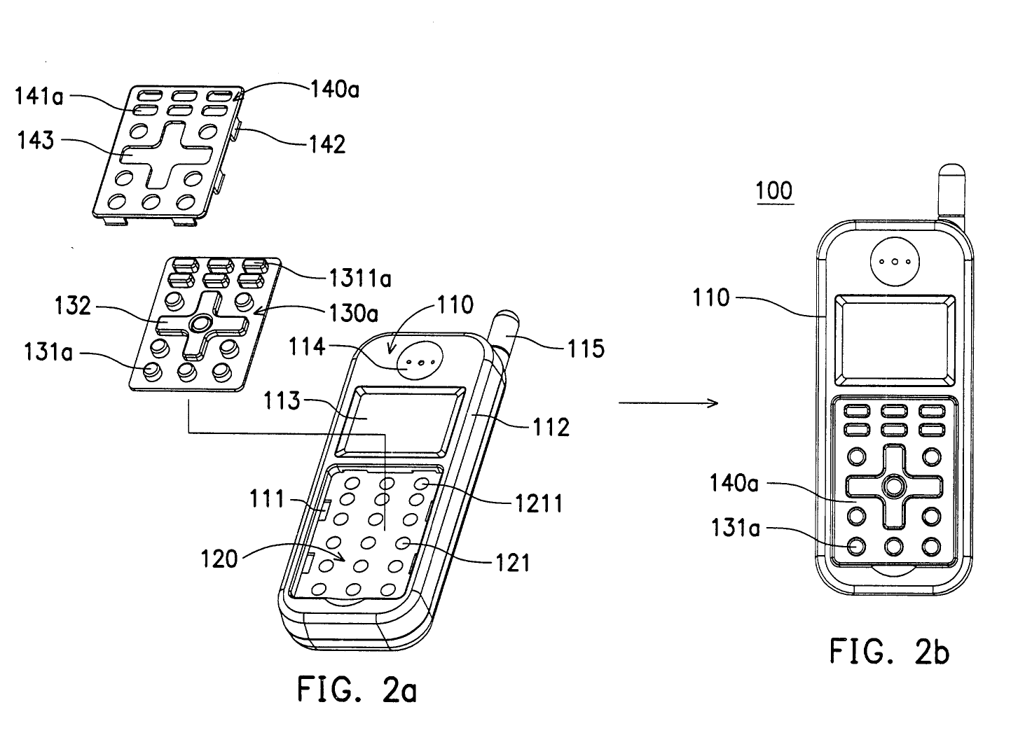

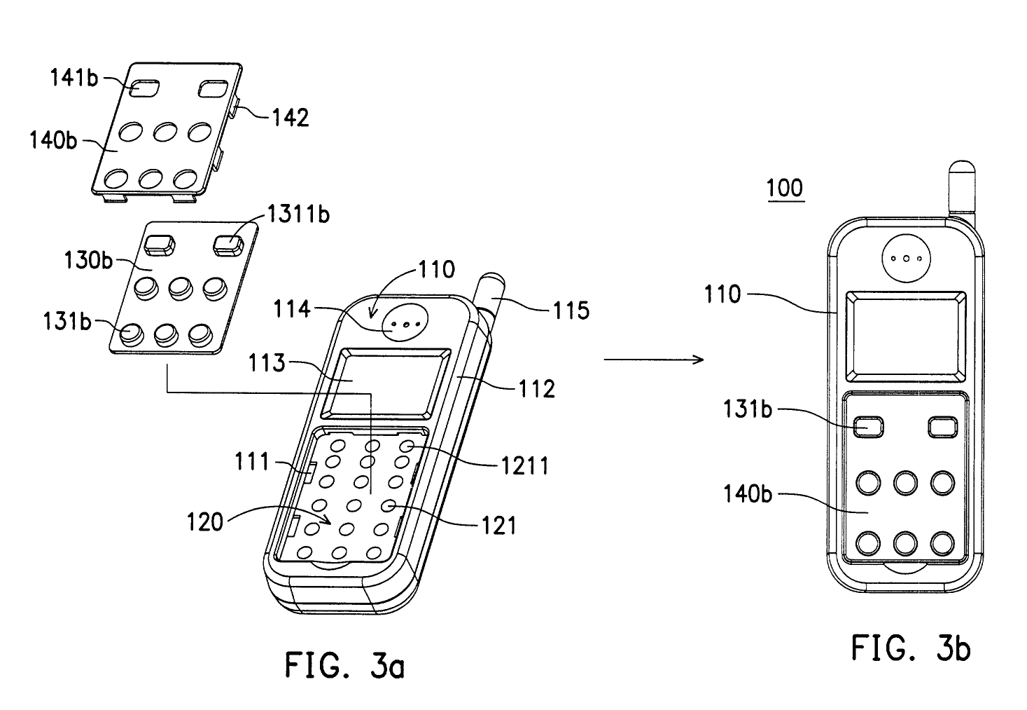

Referring to FIG. 1a, FIG. 1b, FIG. 2a, FIG. 2b, FIG. 3a, and FIG. 3b, a mobile phone 100 as disclosed in this invention is provided. The mobile phone 100 comprises a body 110, a printed circuit board 120, a plurality of key assemblies 130, 130a, 130b, and a plurality of panels 140, 140a, 140b.

The body 110 is a basic element of the mobile phone 100, and includes a plurality of engaging holes 111, a top housing 112, a screen 113, a speaker 114, and an antenna 115 and so on.

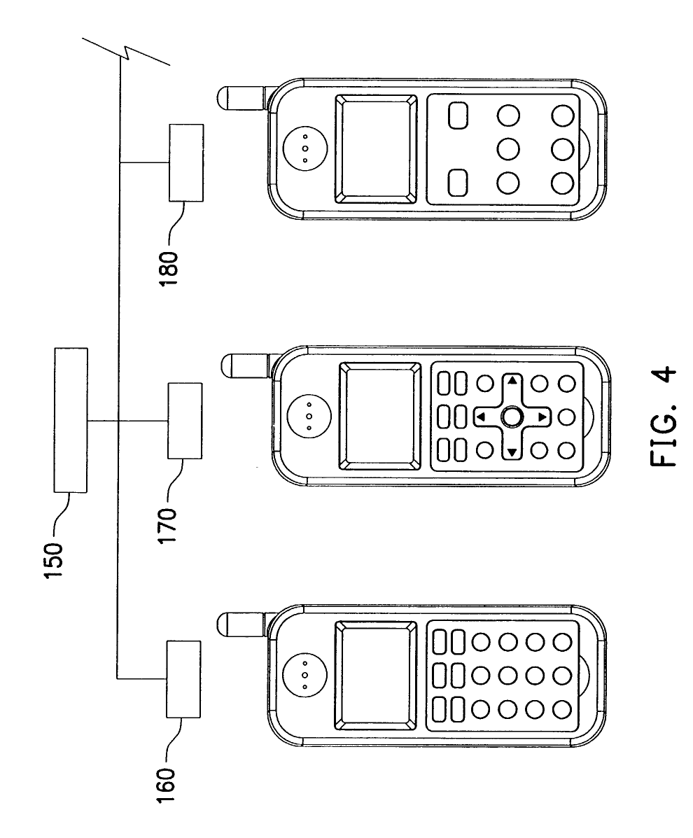

The printed circuit board 120, including a plurality of metal pads 121, is disposed on the body 110. The plurality of pads 121 has a switch pad 1211 for switching modes 160, 170, 180 of software 150, as shown in FIG. 4, to be adapted for different key assemblies 130, 130a, 130b. It is noted that a normal mobile phone may include several printed circuit boards, and only one printed circuit board recieves signals from the key assembly 130, 130a, 130b. In FIG. 1a, FIG. 2a, and FIG. 3a, the printed circuit board 120 is the one to receive signals from the key assembly 130, 130a, 130b.

In FIG. 1a, FIG. 2a, FIG. 3a, the key assemblies 130, 130a, 130b are disposed on the body 110 in a replaceable manner; that is, only one of the key assemblies 130, 130a, 130b can be assembled to the body 110 at the same time, and the key assembly disposed on the body 110 can be replaced. Each of the key assemblies 130, 130a, 130b includes a plurality of keys 131, 131a, 131b. Each of the keys 131, 131a, 131b corresponds to at least one pad 121 of the printed circuit board 120 respectively. The keys 130, 130a, 130b can be electrically coupled to the corresponding pads 121. As a result, each of the keys 131, 131a, 131b is adjacent to at least one pad 121 of the printed circuit board 120 when one of the key assemblies 130, 130a, 130b is disposed on the body 110.

Specifically, the key assembly 130, as shown in FIG. 1a, can be used as a standard type, and suitable for normal users. The key assembly 130a, as shown in FIG. 2a, can be used as a game type, and is provided with a “+”-typed key 132. When the user wants to play games built into the mobile phone 100, the key assembly 130a can be disposed on the body 110. The key assembly 130b, as shown in FIG. 3a, can be used as a simple type, suitable for the elders and children, for whom operation may be difficult.

Since the key assemblies 130, 130a, 130b are replaceable, the software 150 built into the mobile phone 100 is provided with several modes 160, 170, 180. As shown in FIG. 4, in different modes 160, 170, 180, the pads 121 of the printed circuit board 120 can have different definitions. Thus, the printed circuit board 120 can be suitable for different key assemblies 130, 130a, 130b with different numbers of keys 131, 131a, 131b. To achieve the above function, each of the keys 131, 131a, 131b has a switch key 1311, 1311a, 1311b corresponding to the switch pad 1211 of the printed circuit board 120. By pressing the switch key 1311, 1311a, 1311b to be in contact with the switch pad 1211, the printed circuit board 120 can adjust the modes 160, 170, 180 of the software 150 to correspond to the key assembly disposed on the body 110.

The panels 140, 140a, 140b, corresponding to the key assemblies 130, 130a, 130b respectively, are also disposed on the body 110 in a replaceable manner. Each of the panel 140, 140a, 140b includes a plurality of through holes 141, 141a, 141b for the keys 131, 131a, 131b of the corresponding key assemblies panel 130, 130a, 130b to pass through. That is, the keys 131, 131a, 131b of the key assemblies 130, 130a, 130b can pass through the through holes 141, 141a, 141b of the corresponding panels 140, 140a, 140b when one of the panels 140, 140a, 140b is disposed on the body 110.

Furthermore, each of panel 140, 140a, 140b includes a plurality of hooks 142 corresponding to the engaging holes 111 of the body 110 respectively. Thus, one of the panels 140, 140a, 140b is disposed on the body 110 by the hooks 142 engaging with the engaging holes 111.

In addition, the panel 140a is provided with a “+”-typed through hole 143 for the “+”-typed key 132 of the corresponding key assembly 130a to pass through.

It is noted that in this embodiment, the panels 140, 140a, 140b are independent from the top housing 112 of the body 110 of the mobile phone 100. However, the panel 140, 140a, 140b maybe dependent from the top housing 112. In this case, instead of replacing the panels 140, 140a, 140b, the top housing can be replaceable.

As stated above, in the mobile phone as disclosed in this invention, the key assemblies and the panels (or the housings) can be replaced based on different conditions.

It is understood that the concept of this invention is not limited to the mobile phone, and it can be applied for other electronic devices having key assembly.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to housing the disclosed embodiment, those alternatives which have been discussed above, and all equivalents thereto.

What is claimed is:

1. A mobile phone comprising:
a body;
a printed circuit board, including a plurality of pads, disposed on the body; and
a key assembly, disposed on the body in a replaceable manner, including a plurality of keys corresponding to the pads of the printed circuit board respectively.

2. The mobile phone as claimed in claim 1, further comprising:
a panel, disposed on the body in a replaceable manner, including a plurality of through holes for the keys of the key assembly to pass through.

3. The mobile phone as claimed in claim 2, wherein the body includes a plurality of engaging holes, and the panel includes a plurality of hooks corresponding to the engaging holes respectively, whereby the panel is disposed on the body by the hooks engaging with the engaging holes.

4. The mobile phone as claimed in claim 1, further comprising:
a housing, disposed on the body in a replaceable manner, including a plurality of through holes for the keys of the key assembly to pass through.

5. The mobile phone as claimed in claim 4, wherein the body includes a plurality of engaging holes, and the housing includes a plurality of hooks corresponding to the engaging holes respectively, whereby the housing is disposed on the body by the hooks engaging with the engaging holes.

6. The mobile phone as claimed in claim 1, wherein the plurality of pads has a switch pad, and the plurality of keys has a switch key corresponding to the switch pad, whereby the printed circuit board recieves signals from the key assembly by the switch key contacting the switch pad.

7. An electronic device comprising:
a body;
a printed circuit board, including a plurality of pads, disposed on the body; and
a key assembly, disposed on the body in a replaceable manner, including a plurality of keys corresponding to the pads of the printed circuit board respectively.

8. The electronic device as claimed in claim 7, further comprising:
a panel, disposed on the body in a replaceable manner, including a plurality of through holes for the keys of the key assembly to pass through.

9. The electronic device as claimed in claim 8, wherein the body includes a plurality of engaging holes, and the panel includes a plurality of hooks corresponding to the engaging holes respectively, whereby the panel is disposed on the body by the hooks engaging with the engaging holes.

10. The electronic device as claimed in claim 7, further comprising:
a housing, disposed on the body in a replaceable manner, including a plurality of through holes for the keys of the key assembly to pass through.

11. The electronic device as claimed in claim 10, wherein the body includes a plurality of engaging holes, and the housing includes a plurality of hooks corresponding to the engaging holes respectively, whereby the housing is disposed on the body by the hooks engaging with the engaging holes.

12. The electronic device as claimed in claim 7, wherein the plurality of pads has a switch pad, and the plurality of keys has a switch key corresponding to the switch pad, whereby the printed circuit board recieves signals from the key assembly by the switch key contacting the switch pad.
